(19) United States
(12) Patent Application Publication
(10) Pub. No.: US 2005/0019517 A1
(43) Pub. Date: Jan. 27, 2005

(54) Multilayer pipe, in particular for an engine cooling circuit

(75) Inventor: Johann Dabouineau, Dampierre Au Temple (FR)

Correspondence Address: YOUNG & THOMPSON, 745 SOUTH 23RD STREET, 2ND FLOOR, ARLINGTON, VA, 22202, US

(73) Assignee: NOBEL PLASTIQUES, MAROLLES (FR)

(21) Appl. No.: 10/889,116

(22) Filed: Jul. 13, 2004

(30) Foreign Application Priority Data
Jul. 23, 2003 (FR) 0308980

(51) Int. Cl. B32B 1/08

(52) U.S. Cl. 428/36.91

(57) ABSTRACT

A multilayer pipe having an inner layer of thermoplastic material, wherein the thermoplastic material of the inner layer comprises a polymer based on a substituted pentene monomer.

The present invention relates to a multilayer pipe, usable in particular in a cooling circuit of a motor vehicle engine.

### BACKGROUND OF THE INVENTION

There exist numerous single-layer or multilayer pipe structures for use in circuits that convey fluids on board motor vehicles.

The materials selected for making them are the result of a compromise in satisfying numerous constraints.

Thus, the pipes used in such circuits must, in particular, present chemical resistance to the fluid conveyed, and must do so at relatively high temperatures, must present barrier properties to the fluid conveyed, must present resistance to bursting and lengthening at relatively high temperatures (greater than 150° C.) and at relatively high pressures, and resistance to the oxygen dissolved in the fluid.

These constraints are becoming more and more difficult to satisfy because of the increasing performance of vehicle engines and the toughening of antipollution standards.

### OBJECT OF THE INVENTION

The invention seeks to propose a pipe structure which constitutes a compromise that is satisfactory with respect to the above-specified constraints.

### BRIEF SUMMARY OF THE INVENTION

To this end, the invention provides a multilayer pipe having an inner layer comprising a polymer based on a 4-methylpentene-1 monomer, and an outer layer comprising a polyamide.

Other characteristics and advantages of the invention will appear on reading the following description of particular, non-limiting embodiments of the invention.

### BRIEF DESCRIPTION OF THE DRAWINGS

Reference is made to the accompanying drawings, in which:

FIGS. 1 and 2 are cross-section views of a pipe in a first embodiment of the invention and in a variant of said embodiment;

FIG. 3 to 6 are views analogous to FIG. 1 showing a pipe in a second embodiment together with three variants of this embodiment; and

FIG. 7 is a view analogous to FIG. 1 showing a pipe constituting a third embodiment.

### DETAILED DESCRIPTION OF THE INVENTION

With reference to FIG. 1, the pipe constituting the first embodiment of the invention is a two-layer pipe comprising an inner layer 1 and an outer layer 2.

The material used for the inner layer 1, which will come into direct contact with the fluid, is particularly resistant to hydrolysis.

The inner layer 1 is made of a thermoplastic material formed of a polymer based on a mono- or poly-substituted pentene monomer. The substitution serves to increase molecular weight and to improve ability to withstand temperature.

The substituted pentene monomer is a pentene monomer having grafted thereto at least one methyl or ethyl chemical function. More precisely, the material used is a polymer based on 4-methylpentene-1 such as that produced by the supplier Mitsui Chemicals under the references TPX MW-001, MX-002, MX-004, MX-021, DX-810, etc.

Copolymers of the above-specified material can also be used.

The outer layer 2 is made of a thermoplastic material intended in particular for giving the pipe its mechanical strength under pressure and temperature.

The thermoplastic material used comprises polyamide such as a polyamide 6-6, a polyamide 6, a polyamide 6-12, a polyamide 12. The polyamide-based material used is, for example, one of those produced by the supplier EMS Chemié under the references Grilamid L25ANZ, XE3721, or L25AH; or one of those produced by the supplier Degussa-Hüls under the references Vestamid X7394, X7376, LX9202, DX9304, DX9303, BS0628; or indeed one of those produced by the supplier Atofina under the references Rilsan A M-AESN P210 TL or A M-AESN P110 TL. The following materials can also be suitable: polyamide-based materials produced by the supplier Rhodia under the references Technyl A302 or A402; those produced by the supplier Polyone under the reference Bergamid B 80 or B 85; or indeed those produced by the supplier Honeywell under the references Capron 8254 HS, 8354 LF, BE 50 S 2 HI HS, 8255 HS, or HPN 9350 HS.

The material of the inner layer 1 forms a double barrier protecting the material of the outer layer 2 which is poorly resistant to hydrolysis above 100° C.

In a variant, the polyamide-based material used for the outer layer 2 may be stabilized against hydrolysis and/or glycolysis and/or heat.

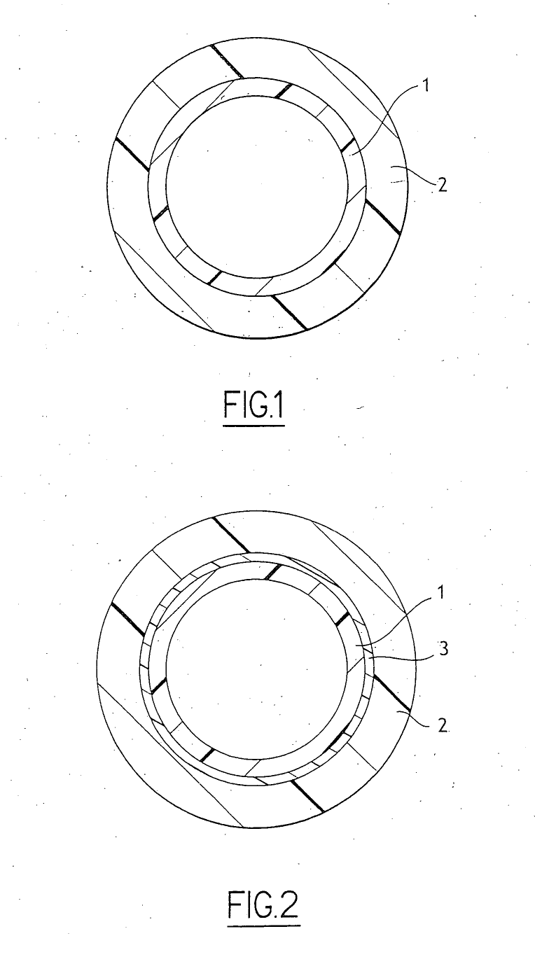

In another variant, as shown in FIG. 2, an intermediate layer 3 is disposed between the inner layer 1 and the outer layer 2.

In this case, the intermediate layer 3 is a bonding layer made of a thermoplastic material that presents adhesive properties relative to the materials of the inner and outer layers 1 and 2.

This material comprises at least one phase which is compatible with the material of the inner layer 1 and which is modified by chemical functions that are compatible with the material of the outer layer 2; or else it comprises at least one phase which is compatible with the material of the outer layer 2 and which is modified by chemical functions that are compatible with the material of the inner layer 1. This material may also be in the form of a mixture of a material that is compatible with the material of the inner layer 1 and a material that is compatible with the material of the outer layer 2.

The material of the intermediate layer 3 is, for example, the material produced by the supplier Mitsui under the reference TLN-4.

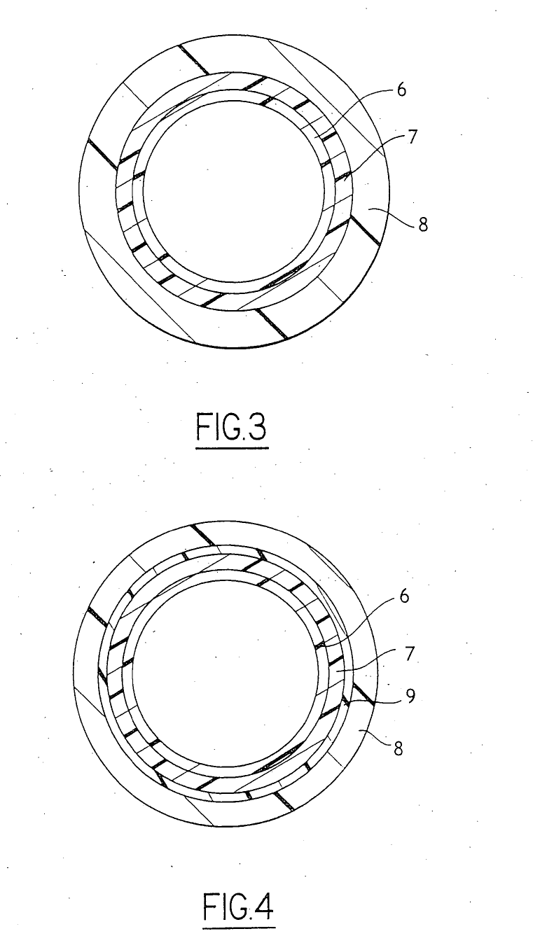

With reference to FIG. 3, the pipe constituting the second embodiment of the invention is a three-layer pipe comprising an inner layer 6, an intermediate layer 7, and an outer layer 8.

The inner layer 6 is made of a thermoplastic material identical to that of the above-described inner layer 1.

The outer layer 8 is made of a thermoplastic material identical to that of the above-described outer layer 2.

The intermediate layer 7 is made of a thermoplastic material comprising a polyolefin. The polyolefin used may be stabilized against hydrolysis and/or heat. The material used in this case is a polypropylene such as that produced by the supplier Basell under the reference Moplen EPD60R or that produced by the supplier Borealis under the reference BHC5012. The polymer used may be another polyolefin such as a polyethylene. The polyolefin provides barrier properties against the fluid conveyed. In particular, the intermediate layer may form even greater protection against hydrolysis because of its water-barrier properties which are very great. These barrier properties further reinforce the barrier properties of the inner layer and provide good protection for the outer layer which serves mainly to provide a function of withstanding pressure and temperature.

In the variant embodiment shown in FIG. 4, an additional intermediate layer 9 is disposed between the intermediate layer 7 and the outer layer 8. The intermediate layer 9 is made of a thermoplastic material which presents adhesive properties relative to the materials of the intermediate layer 7 and of the outer layer 8 in order to provide cohesion between these two layers.

The thermoplastic material used for the intermediate layer 9 in this case is a modified polyolefin such as, for example, a grafted polypropylene, a propylene and ethylene copolymer, or indeed a polyethylene grafted with chemical functions that are compatible with the thermoplastic material of the outer layer 8. This modified polyolefin is, for example, one of those produced by the supplier Mitsui Chemicals under the references Admer and more particularly Admer QF550E, QB510E, AT843E, AT190E, AT1657E, AT1658E, or QF551E. The polyolefin may also be one of those produced by the supplier EMS Chemie under the reference Grilon, and more particularly Grilon XE3153 or CR8E; or it may be one of the materials produced by the supplier Dupont de Nemours under the references Binel, series 5000, and more particularly 50E571 or 50E725.

A thermoplastic elastomer compatible with polyamide may also be used for the intermediate layer 9. This thermoplastic elastomer may, for example, be a polypropylene incorporating rubbery phases such as an ethylene propylene diene monomer (EPDM). The material may incorporate a polyamide phase having the same nature as that used for the outer layer 8.

The thermoplastic elastomer used is, for example, one of those produced by the supplier AES under the references Santoprene, and more particularly Santoprene 191-55PA, 191-75PA, or 191-85PA.

In the variant of FIG. 5, an additional intermediate layer 10 is disposed between the inner layer 6 and the intermediate layer 7.

The intermediate layer 10 is made of a thermoplastic material presenting properties of adhesion with the materials of the inner layer 6 and of the intermediate layer 7. This thermoplastic material comprises at least one phase which is compatible with the material of the inner layer 6 and which is modified by chemical functions compatible with the material of the intermediate layer 7, or it comprises at least one phase which is compatible with the material of the intermediate layer 7 and which is modified by chemical functions compatible with the material of the inner layer 6. The material used for the intermediate layer 10 may also be a mixture of a material that is compatible with the material of the inner layer 6 and a material that is compatible with the material of the intermediate layer 7.

The thermoplastic material used for the intermediate layer 10 is, for example, the material produced by the supplier Mitsui Chemicals under the reference TL221.

The embodiments of FIGS. 3, 4, and 5 are advantageous when the cohesion between the layers that are in direct contact with one another is sufficient for the intended application. Nevertheless, the coupling systems at the ends are designed to compensate for any lack of cohesion of the layers between one another so as to conserve satisfactory mechanical strength and leaktightness at the couplings at the ends of the pipe.

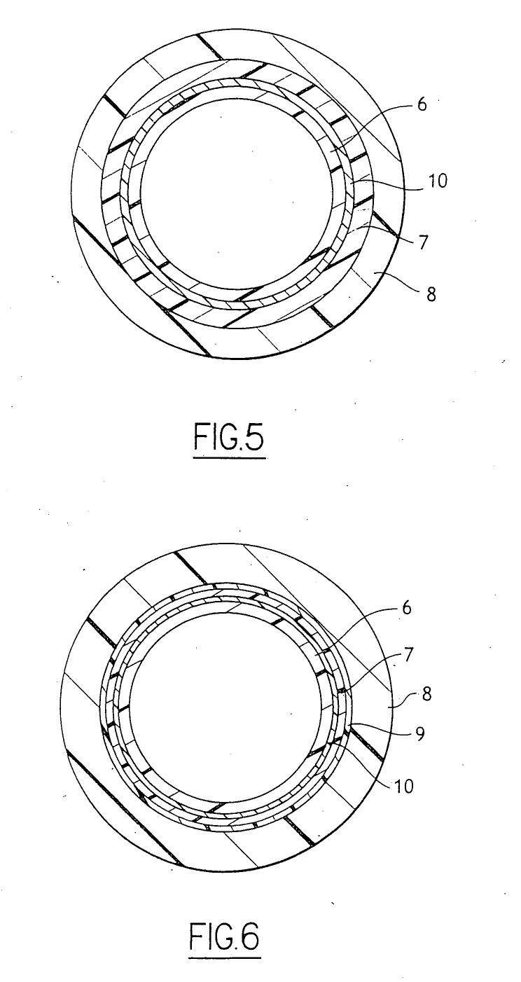

In the variant of FIG. 6, two additional intermediate layers 9 and 10 have been added to the structure described with reference to FIG. 3.

The intermediate layer 9 disposed between the intermediate layer 7 and the outer layer 8 is identical to that described above with reference to FIG. 4.

The intermediate layer 10 disposed between the inner layer 6 and the intermediate layer 7 is identical to that described above with reference to FIG. 5.

This variant is particularly advantageous when relatively strong cohesion is needed between the layers 6, 7, and 8.

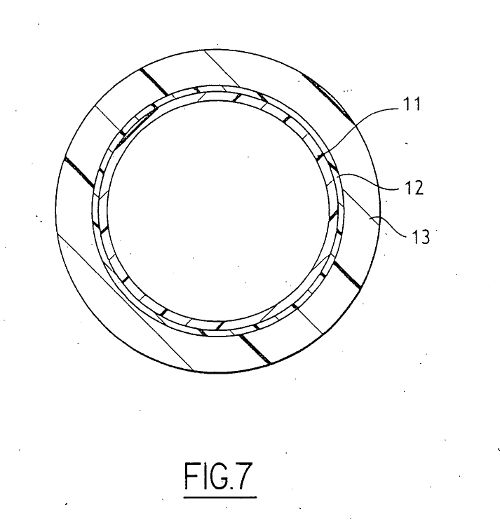

With reference to FIG. 7, the pipe in the third embodiment of the invention is a three-layer pipe comprising an inner layer 11, an intermediate layer 12, and an outer layer 13.

The inner layer 11 is a thermoplastic material identical to that of the above-described inner layer 1.

The material of the intermediate layer 12 is identical to that of the intermediate layer 10 described above.

The material of the outer layer 13 is identical to that of the intermediate layer 7 described above.

This solution is particularly advantageous when the temperature in use does not exceed 100° C. The material of the outer layer 13 then provides sufficient mechanical strength, in particular for pressures of less than about two bars.

The intermediate layer 12 is optional when cohesion between the inner layer 11 and the outer layer 13 is sufficient for the intended application.

The pipes of the embodiments and variants described above are manufactured by co-extruding all of the layers. They can also be obtained by co-extruding some of the layers and then covering them in another layer, or by extruding one layer and then covering it. The pipes may be made by blow extrusion.

The pipes may be smooth or corrugated, and they may be subjected to treatments such as thermoforming.

Naturally, the invention is not limited to the embodiments described and variations can be applied thereto without going beyond the ambit of the invention as defined by the claims.

In particular, the term “pipe” is used to mean any portion of a circuit for conveying fluid.

1. A multilayer pipe, comprising an inner layer comprising a polymer based on a 4-methylpentene-1 monomer, and an outer layer comprising a polyamide.

2. A multilayer pipe according to claim 1, comprising at least one intermediate layer of thermoplastic material.

3. A multilayer pipe according to claim 2, comprising a single intermediate layer in contact with the inner and outer layers, the thermoplastic material of the intermediate layer presenting properties of adhesion with the materials of the inner and outer layers.

4. A multilayer pipe according to claim 2, comprising an intermediate layer whose thermoplastic material comprises a polyolefin.

5. A multilayer pipe according to claim 4, wherein the intermediate layer whose thermoplastic material comprises a polyolefin constitutes a first intermediate layer, and wherein the pipe comprises at least one additional intermediate layer of thermoplastic material.

6. A multilayer pipe according to claim 5, comprising an additional intermediate layer which is disposed between the inner layer and the first intermediate layer, and whose thermoplastic material presents properties of adhesion with the materials of the inner layer and of the first intermediate layer.

7. A multilayer pipe according to claim 5, comprising an additional intermediate layer which is disposed between the first intermediate layer and the outer layer, and whose thermoplastic material comprises a polyolefin modified to be compatible with the materials of the first intermediate layer and of the outer layer.

8. A multilayer pipe according to claim 5, comprising an additional intermediate layer which is disposed between the first intermediate layer and the outer layer, and whose thermoplastic material comprises a thermoplastic elastomer modified to be compatible with the materials of the first intermediate layer and of the outer layer.
